(19) United States
(12) Patent Application Publication
(10) Pub. No.: US 2023/0210148 A1
(43) Pub. Date: Jul. 6, 2023

(54) METHOD FOR PRODUCING COOKED RICE FOR INDIVIDUAL CONSUMPTION USING NON-IMMERSED RICE

(71) Applicant: ACE SYSTEM CO., LTD., Osaka (JP)

(72) Inventor: Yoshihiro SAKO, lzumi-shi (JP)

(73) Assignee: ACE SYSTEM CO., LTD., Osaka (JP)

(21) Appl. No.: 17/998,241

(22) PCT Filed: Jun. 4, 2020
(86) PCT No.: PCT/JP2020/022169

§ 371 Date: Nov. 8, 2022

(30) Foreign Application Priority Data
May 9, 2020 (JP) 2020-082888

(51) Int. Cl. A23L 7/196; A23L 7/10; A23L 3/04

(52) U.S. Cl. CPC A23L 7/1965; A23L 7/197; A23L 3/04

(57) ABSTRACT

Provided is a method for producing cooked rice for individual consumption using non-immersed rice capable of cooking rice having a taste equivalent to that of cooked immersed rice. A method for producing cooked rice for individual consumption using non-immersed rice including: a rice washing step of washing rice; a supply step of supplying washed rice and water into an individual meal cooking container having an open upper surface; a cooking step of cooking the individual meal cooking container to which rice and water are supplied with steam; a sealing step of sealing an upper opening of the individual meal cooking container containing the cooked rice; and a sterilization step of heating the sealed individual meal cooking container, in which in the rice washing step, rice is washed with warm water at 30° C. or more and 80° C. or less.

### TECHNICAL FIELD

The present invention relates to a method for producing cooked rice for individual consumption using non-immersed rice.

### BACKGROUND ART

Conventionally, various types of packaged instant food have been known. For example, various types of food are known, such as food that can be eaten after passage of a predetermined time after pouring hot water, food that can be eaten by heating in a microwave oven, and food that can be eaten by pouring water and heating in a microwave oven.

In particular, in recent years, as instant food, so-called aseptically packaged food in which rice is placed in an individual meal cooking container and aseptically packaged has become widespread. For example, Patent Document 1 (Japanese Unexamined Patent Publication No. 11-20865) discloses a method in which an individual meal cooking container made of a heat-resistant synthetic resin or the like is filled with rice (immersed rice) immersed in water and water (rice cooking water) after washing the rice, and the rice is heated and cooked.

Here, the rice filling the individual meal cooking container is immersed in water as described above in order to cook the rice deliciously, and as the immersed rice, rice that is immersed in water for about 30 to 180 minutes and has absorbed a necessary and sufficient amount of water is usually used.

### PRIOR ART DOCUMENT

### Patent Document

Patent Document 1: Japanese Unexamined Patent Publication No. 11-20865

### SUMMARY OF THE INVENTION

### Problems to be Solved by the Invention

The method described above is a so-called individual meal container rice cooking method in which one serving is cooked, and a method for cooking rice more efficiently in a short time is desired in the case of mass production. In particular, while it is desired to omit the step of immersing rice in water for about 30 to 180 minutes, there is a problem that it is difficult to cook rice having a good taste only by omitting the rice immersion step. In particular, in the case of seasoned rice such as okowa and takikomi-gohan (boiled rice), in the end, the rice is completely impregnated with stock or the like in which a solid component such as a seasoning is dissolved. However, when the immersion step is omitted, the center of the rice is not impregnated with the stock, and the rice has a core. This is because water molecules in the stock in which a solid component is dissolved are less likely to permeate rice than water molecules in fresh water in which such a component is not dissolved.

The present invention has been made to solve such a problem, and an object of the present invention is to provide a method for producing cooked rice for individual consumption using non-immersed rice capable of cooking rice having a taste equivalent to that of cooked immersed rice.

### Means for Solving the Problem

The object of the present invention is achieved by a method for producing cooked rice for individual consumption using non-immersed rice including: a rice washing step of washing rice; a supply step of supplying washed rice and water into an individual meal cooking container having an open upper surface; a cooking step of cooking the individual meal cooking container to which rice and water are supplied with steam; a sealing step of sealing an upper opening of the individual meal cooking container containing the cooked rice; and a sterilization step of heating the sealed individual meal cooking container, in which in the rice washing step, rice is washed with warm water at 30° C. or more and 80° C. or less.

Additionally, in the method for producing cooked rice for individual consumption using non-immersed rice, in the rice washing step, rice is preferably washed with the warm water for a time of 2 minutes or more and 5 minutes or less.

Additionally, in the supply step, a temperature of the water supplied into the individual meal cooking container is preferably lower than a temperature of the warm water used in the rice washing step.

Additionally, a moisture content of rice at the end of the rice washing step is preferably 18% or more and 28% or less.

Additionally, the cooked rice preferably has a rice cooking ratio of 2.3 or more and 2.6 or less.

Additionally, it is preferable that the individual meal cooking container includes a bottom surface part and a side wall part erected from a periphery of the bottom surface part, the bottom surface part has a rough surface part, and the rough surface part is formed of a plurality of minute protrusions protruding from an inner surface of the bottom surface part and arranged at predetermined intervals.

### Effect of the Invention

According to the present invention, it is possible to provide a method for producing cooked rice for individual consumption using non-immersed rice capable of cooking rice having a taste equivalent to that of cooked immersed rice.

### BRIEF DESCRIPTION OF THE DRAWINGS

FIG. 1 is a block diagram for describing a method for producing cooked rice for individual consumption using non-immersed rice according to an embodiment of the present invention.

FIG. 2 is a schematic view showing an example of a system for carrying out the method for producing cooked rice for individual consumption according to the present invention.

FIG. 3 is a plan view of an individual meal cooking container suitably used in the method for producing cooked rice for individual consumption according to the present invention.

FIG. 4 is a schematic cross-sectional view taken along line A-A in FIG. 3.

FIG. 5 is an enlarged view of a main part of FIG. 4.

FIG. 6 is an enlarged view of a main part of FIG. 3.

FIG. 7 is an enlarged cross-sectional view of a main part of a schematic configuration showing a modification of the individual meal cooking container shown in FIG. 3.

### EMBODIMENT OF THE INVENTION

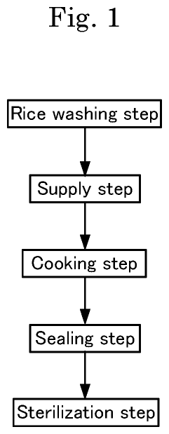

Hereinafter, a method for producing cooked rice for individual consumption using non-immersed rice according to an embodiment of the present invention will be described with reference to the accompanying drawings. As shown in the block diagram of FIG. 1, the method for producing cooked rice for individual consumption according to the present invention includes a rice washing step, a supply step, a cooking step, a sealing step, and a sterilization step.

The rice washing step is a step of washing rice. While the specific configuration of the rice washing method is not particularly limited, it is preferable to wash rice by a method in which the surface of each grain of rice is washed so as to be sufficiently in contact with hot water used for washing rice, and the surface is gently washed so as not to be damaged, for example. This is because when the surface of the rice is broken, the rice becomes waste and flows out and is discarded uselessly. Also, when the cells near the surface of the rice are crushed, swelling when the rice becomes cooked rice is deteriorated, the stickiness of the surface is increased, and the taste is also deteriorated. In order to enable washing of rice as described above, it is preferable to wash rice with flowing water at a flow rate that is not too large. Additionally, the rice may be washed with flowing water having a flow rate that is not too large in the first half of the rice washing, and then rice washing performed by pooling hot water in a container may be repeated several times. Alternatively, for example, rice put in a sieve may be immersed in hot water that has been once pooled and be lightly stirred with the hand or the like 2 or 3 times, and the pooled hot water may be quickly drained. Thereafter, the rice may be washed by moving only the sieve while flowing water without using the hand or the like, not unnecessarily stirring the rice with the hand or the like.

Additionally, in the rice washing step in the present invention, rice is washed with warm water at 30° C. or more and 80° C. or less. Note that in this rice washing step, it is more preferable to wash the rice with warm water at 40° C. or more and 60° C. or less. When washing rice using warm water at 40° C. or more and 60° C. or less, rice can absorb water in a shorter time, and occurrence of partial gelatinization of the surface of rice can be effectively curbed. Additionally, in this rice washing step, it is preferable to wash rice with warm water in the above temperature range for a time of 2 minutes or more and 5 minutes or less. Additionally, it is preferable to wash the rice with warm water so that the moisture content of the rice at the end of the rice washing step falls within the range of 18% or more and 28% or less.

The supply step is a step of supplying washed rice and water into an individual meal cooking container having an open upper surface. The individual meal cooking container is a container that can cook rice by heating at least rice (e.g., milled rice, brown rice, and mixed grain rice) and water contained therein, and conventionally known containers can be used. Such an individual meal cooking container is produced, for example, by press molding, injection molding, vacuum molding, or the like using a synthetic resin sheet. Additionally, an individual meal cooking container 1 can be configured to have flexibility. As the synthetic resin sheet, for example, a sheet formed of a thermally flexible plastic such as non-expanded polystyrene, expanded polystyrene, non-expanded polypropylene, expanded polypropylene, non-expanded polyethylene, expanded polyethylene, or polyethylene terephthalate so as to have appropriate hardness and toughness can be used.

Here, as the temperature of the water to be put into the individual meal cooking container containing the washed rice, it is preferable to put water having a temperature lower than the temperature of the warm water used in the rice washing step. For example, it is preferable to put in water at 2° C. to 40° C. A too rapid temperature rise of the water around the rice may excessively increase the progress rate of gelatinization of the surface of rice, and when the progress of gelatinization is too fast, there is a risk that permeation of water into rice is hindered. In order to prevent such a situation from occurring and to allow moisture to sufficiently permeate the rice at the time of final cooking, it is preferable to use water at 2° C. to 40° C. for rice cooking as described above.

The cooking step is a step of heating the individual meal cooking container to which rice and water are supplied with steam to cook the rice. The steam may be steam at around 100° C. or superheated steam at 100° C. or higher. Examples of the heating condition in this cooking step include a condition of 97° C. to 105° C. for 15 minutes to 30 minutes, and preferably a condition of 100° C. to 102° C. for 20 minutes to 25 minutes. Note that superheated steam means steam superheated to a temperature equal to or higher than the temperature (100° C. at 1 atm, boiling point at other than 1 atm) of saturated steam, unlike saturated steam. Superheated steam is obtained by various superheaters. The superheater is known, and the superheating method is not limited. Additionally, the rice cooked in the cooking step preferably has a rice cooking ratio of 2.3 or more and 2.6 or less. Note that a rice cooking ratio refers to a ratio of the weight of cooked rice to the weight of uncooked rice. That is, a rice cooking ratio indicates the weight ratio of cooked rice when the weight of uncooked rice is 1. Here, it is preferable that the humidity around the individual food container when cooking the individual food container with steam is 80% or more, and preferably, as close to 100% as possible. This is because while the water in the individual food container during rice cooking eventually boils, if the surrounding humidity is high, the water does not boil so that air bubbles are intensely generated. As a result, the cooked rice will have less loss of shape of rice grains and have maintained rice cells since there is less physical impact on the rice.

The sealing step is a step of sealing the upper opening of the individual meal cooking container that contains the cooked rice with a sealing material. A sealing material is a member for sealing the upper opening of the individual meal cooking container, and is usually a sheet-like or film-like member. In the present invention, it is preferable to use a plastic film as the sealing material. While various conventionally-known sealing methods can be adopted as the sealing step, it is preferable to seal the upper opening of the individual meal cooking container by sticking or thermally fusing with a plastic film subjected to a sterilization treatment.

The sterilization step is a step of sterilizing the sealed individual meal cooking container by heating. In this sterilization step, for example, the individual meal cooking container 1 is sterilized by heating at 100° C. to 120° C. The sterilization method in the sterilization step is not particularly limited, and for example, a method in which steam is applied to a sealed individual meal cooking container to pressurize and heat the container, a method in which a sealed individual meal cooking container is enclosed in a sterilization chamber to pressurize and heat the container, and the like can be suitably used.

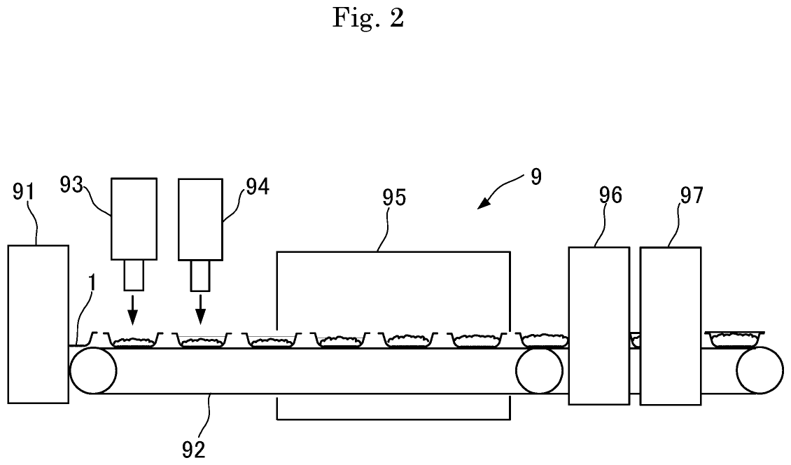

The method for cooking non-immersed rice according to the present invention can be carried out, for example, using a production system shown in the schematic diagram of FIG. 2. This production system includes a container supply device 91 that supplies the individual meal cooking container 1, a conveyance device 92 such as a belt conveyor, a rice-washing and rice-supplying device 93 for washing rice and supplying the washed rice to the individual meal cooking container 1, a water supply device 94 that supplies water to the individual meal cooking container 1, a rice cooking chamber 95, a sealing device 96, and a heat sterilization device 97. The conveyance device 92 is configured to pass through rice cooking chamber 95. Note that when the cooked rice contained in the individual meal cooking container 1 is cooked as takikomi-gohan (boiled rice), an ingredient supply device capable of supplying ingredients of takikomi-gohan to the individual meal cooking container 1 is separately provided before the individual meal cooking container 1 is guided into the rice cooking chamber 95.

First, by the action of the container supply device 91, the individual meal cooking containers 1 are supplied one by one onto a conveyance surface of the conveyance device 92. Next, a predetermined amount of washed rice is supplied, through the rice-washing and rice-supplying device 93, to each of the individual meal cooking containers 1 supplied onto the conveyance surface (rice washing step and supply step). Here, in the rice-washing and rice-supplying device 93, the rice is washed with warm water at 30° C. or more and 80° C. or less (rice washing step). Additionally, the rice to be washed by the rice-washing and rice-supplying device 93 is washed with warm water in the above temperature range for a time of 2 minutes or more and 5 minutes or less, for example (rice washing step). Additionally, a predetermined amount of water is supplied, through the water supply device 94, to each of the individual meal cooking containers 1 supplied onto the conveyance surface (supply step). The individual meal cooking containers 1 containing washed rice and water are sequentially guided into the rice cooking chamber 95 by the conveyance device 92, and heated in the rice cooking chamber 95 by superheated steam for a predetermined time to cook rice (cooking step). Note that superheated steam supplied from a superheated steam generator (not shown) is supplied to the rice cooking chamber 95.

After completion of the rice cooking, the individual meal cooking container 1 is conveyed to the sealing device 96, and the upper opening of the individual meal cooking container 1 is covered with a sealing material to be closed and thermally welded under a clean environment. Thus, the individual meal cooking container 1 is sealed (sealing step). Thereafter, in the heat sterilization device 97, for example, the individual meal cooking container 1 is heated at a temperature of 100° C. to 120° C. (sterilization step), thereby completing an aseptically packaged sealed container containing cooked rice that can be stored at normal temperature for about 1 week.

Since the method for producing cooked rice for individual consumption according to the present invention includes, in the rice washing step of washing rice, a step of washing rice with warm water at 30° C. or higher and 80° C. or lower, the distance between rice cells is increased in the rice washing step, and the rice can absorb water efficiently in the rice washing step. Hence, it is possible to produce cooked rice for individual consumption having a taste equivalent to that in the case of cooking immersed rice even when the rice immersion step, which has been conventionally necessary, is omitted, that is, even when non-immersed rice is used. Additionally, in the method for producing cooked rice for individual consumption according to the present invention, since the rice immersion step can be omitted, the cooked rice for individual consumption can be efficiently produced in a shorter time. Furthermore, in the supply step, water supplied into the individual meal cooking container is water having a low temperature of 2° C. to 40° C. By putting the water having a low temperature of 2° C. to 40° C. around the rice contained in the individual meal cooking container, it is possible to make the rice absorb water more efficiently, and even when non-immersed rice is used, it is possible to produce cooked rice for individual consumption having a taste equivalent to that of rice cooked with immersed rice in a short time.

Additionally, the temperature of warm water and the rice-washing time in the rice washing step are controlled so that the moisture content of the rice at the end of the rice washing step falls within the range of 18% or more and 28% or less. Hence, it is possible to produce cooked rice for individual consumption having a taste at a level comparable to that in the case of cooking immersed rice.

Additionally, the cooked rice contained in the aseptically packaged, sealed container of cooked rice is preferably cooked at a rice cooking ratio of 2.1 or more and 2.6 or less. In particular, the rice is preferably cooked at a rice cooking ratio of 2.3 or more and 2.6 or less. Note that a rice cooking ratio refers to a ratio of the weight of cooked rice to the weight of uncooked rice. That is, a rice cooking ratio indicates the weight ratio of cooked rice when the weight of uncooked rice is 1. The rice cooking ratio of common cooked rice is 2.1 or more and 2.2 or less. However, by setting the rice cooking ratio to a range of 2.3 or more and 2.6 or less, for example, when the cooked rice having a rice cooking ratio of 2.1 and the cooked rice having a rice cooking ratio of 2.3 are compared at the same weight, the calories can be reduced by about 10%, and the cooked rice can be provided to the user as a health-conscious product.

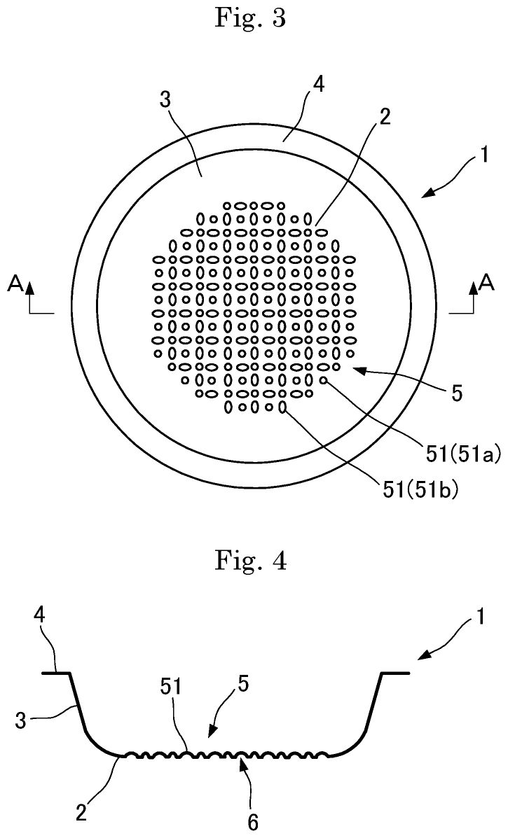

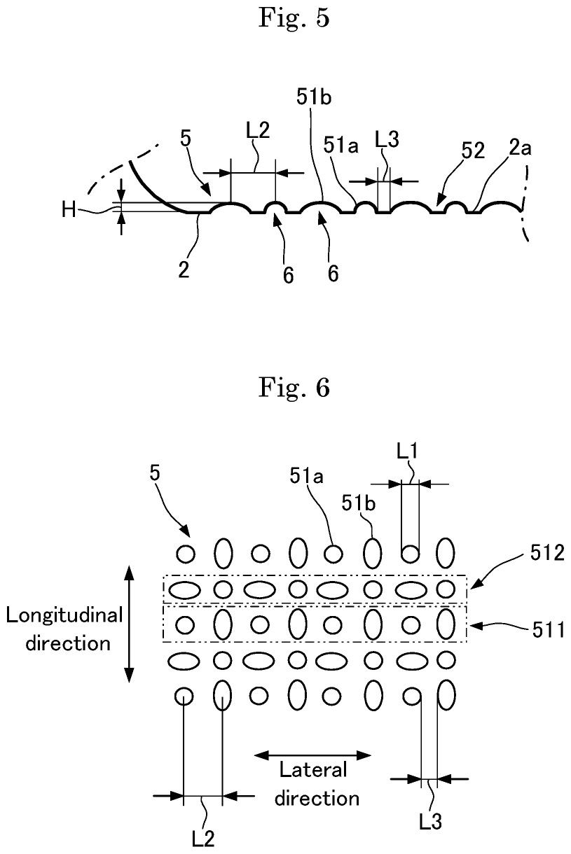

Here, while a container having a conventionally known structure can be used as the individual meal cooking container containing the washed rice and water, an individual meal cooking container as shown in the plan view of FIG. 3 or FIG. 4 showing an A-A cross section thereof can be suitably used, for example. Note that FIG. 5 is an enlarged view of a main part of FIG. 4, and FIG. 6 is an enlarged view of a main part of FIG. 3. The individual meal cooking container includes a circular bottom surface part 2, a side wall part 3 erected upward from a periphery (peripheral edge) of the bottom surface part 2, and a flange part 4 provided around an upper end part (opening) of the side wall part 3.

The bottom surface part 2 is a part forming the bottom surface of the individual meal cooking container 1, and the thickness of the bottom surface part 2 is preferably set to a range of 0.5 mm or more and 5.0 mm or less, for example. Additionally, the diameter of the bottom surface part 2 can be appropriately set depending on the amount of rice and water to be contained therein. For example, in the case of forming the individual meal cooking container 1 for one serving (e.g., cooked rice having a weight of 150 g), the diameter is preferably set to a range of 50 mm or more and 120 mm or less, for example. As shown in FIGS. 3 to 6, the bottom surface part 2 includes a rough surface part 5. The rough surface part 5 is formed of a plurality of minute protrusions 51 protruding from an inner surface of the bottom surface part 2 toward the containing space side and arranged at predetermined intervals. The plurality of minute protrusions 51 are arranged in a lattice pattern over substantially the entire region of the bottom surface part 2. Note that a gap 52 is formed between the protrusions 51. Here, it is preferable that each protrusion 51 is configured such that a width dimension L1 at the bottom thereof is in a range of 0.3 times or more and 1.5 times or less the width dimension of uncooked rice in plan view. Additionally, it is preferable that a height dimension H (height dimension from inner surface to top part of bottom surface part 2) of each protrusion 51 is configured to be in a range of 0.3 times or more and 0.8 times or less the width dimension of uncooked rice. Additionally, it is preferable that an inter-vertex dimension L2 between one protrusion 51 and each of the other protrusions 51 disposed adjacent to and around the one protrusion 51 is configured to be in a range of 0.3 times or more and 2.3 times or less the width dimension of uncooked rice. In the present embodiment, since the grid-like arrangement is adopted as the arrangement structure of the protrusions 51, it is preferable that the dimension L2 between the vertices of the protrusions 51 adjacent to each other in the lateral direction and the longitudinal direction is in the range of 0.3 times or more and 2.3 times or less the width dimension of uncooked rice. Note that as shown in FIG. 5, in a case where a flat inner surface 2a of the bottom surface part 2 appears between the protrusions 51, a dimension L3 between boundaries of the inner surface of the bottom surface part 2 and the skirt part of the protrusions 51 (51a, 51b) is preferably smaller than the width dimension of uncooked rice, and particularly preferably in a range of 0.3 times or more and 0.8 times or less the width dimension of uncooked rice.

Here, the width dimension of uncooked rice refers to the maximum width in the lateral direction of one grain of uncooked rice. Additionally, for example, the maximum width can be measured for each of a plurality of (e.g., 25 grains, 50 grains, 100 grains, and the like) uncooked rice, and the average value thereof can be taken as the width dimension of uncooked rice.

Additionally, as shown in the cross-sectional view of FIG. 4, in the present embodiment, on an outer surface of the bottom surface part 2, a recess 6 recessed toward the inner surface of the bottom surface part 2 is formed at a position corresponding to each of the protrusions 51 described above. Each recess 6 has a structure recessed toward the vertex of the corresponding protrusion 51. Here, each recess 6 is preferably configured such that the width dimension of its opening is in a range of 0.5 mm or more and 5 mm or less. The depth of each recess 6 is preferably in a range of 0.05 mm or more and 5 mm or less.

Additionally, the plurality of protrusions 51 forming the rough surface part 5 are configured as a set of first protrusions 51a and second protrusions 51b. The second protrusion 51b is configured as a protrusion 51 having a larger surface area than the first protrusion 51a. Additionally, the first protrusions 51a and the second protrusions 51b are alternately arranged in the lateral direction and the longitudinal direction.

In the present embodiment, as illustrated in the enlarged cross-sectional view of the main part of FIG. 5 and the enlarged plan view of the main part of FIG. 6, each of the first protrusions 51a is formed in a hemispherical shape, and each of the second protrusions 51b is formed in a semi-elliptical spherical shape. In other words, the first protrusion 51a is configured to have a circular contour in plan view, and the second protrusion 51b is configured to have an elliptical contour in plan view. Additionally, the maximum width of each hemispherical first protrusion 51a (width at connection part with bottom surface part 2) is configured to be substantially the same dimension as the width of each semi-elliptical spherical second protrusion 51b in the minor axis direction (width at connection part with bottom surface part 2).

Additionally, the inner surface shape of each recess 6 formed on the outer surface of the bottom surface part 2 at a position corresponding to each first protrusion 51a is formed in a hemispherical shape. Similarly, the inner surface shape of each recess 6 formed on the outer surface of the bottom surface part 2 at a position corresponding to each second protrusion 51b is formed in a semi-elliptical spherical shape along the semi-elliptical spherical second protrusion 51b.

Additionally, as illustrated in FIG. 6, for example, focusing on one protrusion group 511 arranged in the lateral direction, each of the second protrusions 51b having the elliptical contour arranged in the one protrusion group 511 is arranged such that the minor axis direction thereof is along the lateral direction (arrangement direction of one protrusion group 511), and each of the second protrusions 51b arranged in another protrusion group 512 arranged in the lateral direction adjacent to the upper side (or lower side) of the one protrusion group 511 is arranged such that the major axis direction thereof is along the lateral direction (arrangement direction of other protrusion group 512). Additionally, focusing on the one protrusion group 511 and the other protrusion group 512, the first protrusions 51a and the second protrusions 51b are alternately arranged along the lateral direction.

The side wall part 3 is a part forming a side surface of the individual meal cooking container 1, and is configured to rise upward from a periphery (peripheral edge) of the bottom surface part 2 as described above. As shown in the cross-sectional view of FIG. 4, the side wall part 3 is formed so as to expand outward toward the upper side from the bottom surface part 2. The thickness of the side wall part 3 is preferably the same dimension as the thickness of the bottom surface part 2. Additionally, the height of the side wall part 3 can be appropriately set depending on the amount of rice and water to be contained therein. For example, in the case of forming the individual meal cooking container 1 for one serving, the height is preferably set to a range of 20 mm or more and 100 mm or less, for example.

The flange part 4 is a part to which a sealing material (not illustrated) serving as an exterior of the package is attached by thermal welding or the like, and is configured to have a surface (sticking surface with seal part) extending outward in the horizontal direction from an upper end part of the side wall part 3. The flange part 4 is formed in a ring shape in plan view. The thickness of the flange part 4 can be equal to the thickness of the bottom surface part 2, but is preferably set to be larger than the thickness of the bottom surface part 2 in consideration of prevention of damage when the seal part is thermally fused.

When rice is cooked using the individual meal cooking container as shown in FIGS. 3 to 6, the following effects can be obtained. In other words, the individual meal cooking container 1 containing cooked rice includes the rough surface part 5 formed of the plurality of minute protrusions 51 protruding from the inner surface of the bottom surface part 2 and arranged at predetermined intervals, so that adhesion between the cooked rice contained in the container and the bottom surface part 2 can be weakened, and the cooked rice can be easily taken out without sticking on the surface of the bottom surface part 2 when the seal part is removed to eat the cooked rice. Note that cooked rice having a rice cooking ratio of 2.3 or more and 2.6 or less has a large moisture content and thus tends to be sticky. However, as described above, since the individual meal cooking container 1 includes the rough surface part 5, even the cooked rice having a rice cooking ratio of 2.3 or more and 2.6 or less is less likely to stick to the surface of the bottom surface part 2.

Additionally, the individual meal cooking container 1 includes the rough surface part 5 described above, so that the surface area of the inner surface of the bottom surface part 2 is increased. This makes it possible to effectively impart heat supplied to the bottom surface part 2 during rice cooking to rice and water contained in the individual meal cooking container 1. That is, the amount of heat transfer during rice cooking can be increased, so that rice cooking can be efficiently performed.

In particular, the recess 6 recessed toward the inner surface of the bottom surface part 2 is formed on the outer surface of the bottom surface part 2 at a position corresponding to each protrusion 51, so that the surface area of the outer surface of the bottom surface part 2 is also increased. Hence, the amount of heat absorbed by the container from the outside of the individual meal cooking container 1 can be increased during rice cooking, and the rice cooking can be more efficiently performed.

Additionally, each of the recesses 6 formed on the outer surface of the bottom surface part 2 is recessed toward the vertex of the corresponding protrusion 51, so that the distance between the inner surface of each recess 6 and the outer surface of each protrusion 51 can be reduced. Hence, the heat supplied from the outside of the individual meal cooking container 1 can be efficiently transmitted to the inner surface side of the bottom surface part 2, and heat transfer loss can be reduced to heat the rice and water contained in the individual meal cooking container 1.

Additionally, since the rough surface part 5 includes the plurality of minute protrusions 51, it is possible to reduce the contact area between the bottom surface part 2 and the rice grains contacting the bottom surface part 2 at the time of rice cooking, and to create a situation in which water exists between the bottom surface part 2 and the rice at the time of rice cooking. As a result, the cooked rice is less likely to stick to the surface of the bottom surface part 2, and appropriate water and temperature can be given to the rice present near the bottom surface part 2, so that the taste of the cooked rice can be improved.

In particular, by setting the height dimension H of each protrusion 51 to be in the range of 0.3 times or more and 0.8 times or less the width dimension of uncooked rice, it is possible to effectively keep the surface of the rice from sticking to the surface of the bottom surface part 2 when the rice absorbs moisture and expands during cooking, and it is possible to form a space between the cooked rice and the bottom surface part 2 at the end of cooking, so that it is possible to easily take out the rice from the container while eating. Note that when the height dimension H of each protrusion 51 exceeds 0.8 times the width dimension of uncooked rice, uncooked rice may be placed in a standing state in the gap 52 between the protrusions 51 of the bottom surface part 2. In such a case, there is a risk that the surface of the rice comes into contact with the surface of the protrusion 51 in a wide range, and the cooked rice may become sticky. Additionally, when the height dimension H of each protrusion 51 is set to a value less than 0.3 times the width dimension of uncooked rice, the risk that the expanded rice comes into contact with the surface of the bottom surface part 2 in the rice cooking process increases, and the cooked rice may become sticky.

Additionally, by setting the dimension L2 between the vertices of the protrusions 51 to be in the range of 0.3 times or more and 2.3 times or less the width dimension of uncooked rice, it is possible to effectively reduce the area of the bottom surface part 2 in contact with one grain of uncooked rice and to effectively create a situation in which water exists between the bottom surface part 2 and rice placed on the bottom surface part 2 during rice cooking. Hence, it is possible to further enhance the aforementioned effect of making the cooked rice less likely to stick to the surface of the bottom surface part 2 and the effect of improving taste. Note that if the dimension L2 between the vertices of the protrusions 51 is set to less than 0.3 times the width dimension of uncooked rice, the number of protrusions 51 in contact with one grain of uncooked rice increases. As a result, the area per grain of uncooked rice in contact with the bottom surface part 2 increases, and the risk of stickiness of cooked rice increases. In addition, when the dimension L2 between the vertices of the protrusions 51 is set to a dimension exceeding 2.3 times the width dimension of uncooked rice, there is a high risk that the number of uncooked rice coming into contact with a part other than the protrusions 51 (flat inner surface 2a of bottom surface part 2 existing between protrusions 51) increases, and the cooked rice may become sticky.

Additionally, as shown in FIG. 5, when the flat inner surface 2a of the bottom surface part 2 appears between the protrusions 51, by setting the dimension L3 between boundaries of the inner surface of the bottom surface part 2 and the skirt part of the protrusion 51 (51a, 51b) to be in the range of 0.3 times or more and 0.8 times or less the width dimension of uncooked rice, it is possible to effectively reduce the area of the bottom surface part 2 in contact with one grain of uncooked rice and to more effectively create a situation where water exists between the bottom surface part 2 and rice placed on the bottom surface part 2 during rice cooking. Hence, it is possible to further enhance the aforementioned effect of making the cooked rice less likely to stick to the surface of the bottom surface part 2 and the effect of improving taste. When the dimension L3 is set to less than 0.3 times the width dimension of uncooked rice, the number of protrusions 51 in contact with one grain of uncooked rice increases, and as a result, the area per grain of uncooked rice in contact with the bottom surface part 2 increases, and the risk of stickiness of cooked rice increases. In addition, when the dimension L3 is set to a dimension exceeding 0.8 times the width dimension of uncooked rice, there is a high risk that the number of uncooked rice coming into contact with a part other than the protrusion 51 (flat inner surface 2a of bottom surface part 2 existing between protrusions 51) increases, and the cooked rice may become sticky.

Additionally, the rough surface part 5 is configured as a set of the first protrusions 51a and the second protrusions 51b having a larger surface area than the first protrusions 51a, and the first protrusions 51a and the second protrusions 51b are alternately arranged. Hence, the area of contact between the surface of the bottom surface part 2 and the rice grains can be more effectively reduced during rice cooking, and the heat transfer amount during rice cooking can be increased by increasing the surface area of the bottom surface part 2, so that rice cooking can be more efficiently performed.

Additionally, the inner surface shape of each recess 6 formed on the outer surface of the bottom surface part 2 at the position corresponding to each first protrusion 51a is formed in a hemispherical shape, and similarly, the inner surface shape of each recess 6 formed on the outer surface of the bottom surface part 2 at the position corresponding to each second protrusion 51b is formed in a semi-elliptical spherical shape. With such a configuration, the surface area of the outer surface of the bottom surface part 2 can be further increased, so that the amount of heat absorbed by the container from the outside of the individual meal cooking container 1 can be further increased during rice cooking, and rice cooking can be performed extremely efficiently.

Note that while the bottom surface part 2 of the individual meal cooking container 1 shown in FIGS. 3 to 6 is formed in a circular shape in plan view, the present invention is not particularly limited to such a configuration. For example, the bottom surface part 2 may have a polygonal shape such as a quadrangular shape, a pentagonal shape, or a hexagonal shape in plan view, or may have an elliptical shape.

Additionally, in the individual meal cooking container 1 shown in FIGS. 3 to 6, the plurality of protrusions 51 forming the rough surface part 5 are configured as a set of the first protrusions 51a and the second protrusions 51b having a larger surface area than the first protrusions 51a. However, the present invention is not particularly limited to such a configuration, and all the protrusions 51 may be configured to have the same shape having the same surface area, that is, for example, all the protrusions 51 may be configured to have a circular contour in plan view, or may be configured to have an elliptical contour in plan view.

Additionally, in the individual meal cooking container 1 shown in FIGS. 3 to 6, the first protrusion 51a is configured to have a circular contour in plan view. However, the first protrusion 51a may be configured as a protrusion 51 having an elliptical contour having a surface area smaller than the surface area of the second protrusion 51b having an elliptical contour in plan view. Similarly, in the individual meal cooking container 1 shown in FIGS. 3 to 6, the second protrusion 51b is configured to have an elliptical contour in plan view. However, the second protrusion 51b may be configured as a protrusion 51 having a circular contour having a surface area larger than the surface area of the first protrusion 51a having a circular contour in plan view.

Additionally, in the individual meal cooking container 1 shown in FIGS. 3 to 6, the protrusions 51 are arranged in a lattice pattern in plan view, but the present invention is not particularly limited to such a configuration. For example, the protrusions 51 may be arranged in a zigzag pattern, a random pattern, or the like. Even in the case of adopting such an arrangement structure, it is preferable that the inter-vertex dimension L2 between one protrusion 51 and each of the other protrusions 51 disposed adjacent to and around the one protrusion 51 is in a range of 0.3 times or more and 2.3 times or less the width dimension of uncooked rice. Note that the width dimension L1 at the bottom of each protrusion 51 is also preferably in the range of 0.3 times or more and 1.5 times or less the width dimension of uncooked rice as described above. Additionally, in a case where the flat inner surface 2a of the bottom surface part 2 appears between the protrusions 51, the dimension L3 between boundaries of the inner surface of the bottom surface part 2 and the skirt part of the protrusions 51 (51a, 51b) is preferably in the range of 0.3 times or more and 0.8 times or less the width dimension of uncooked rice as described above.

Additionally, in the individual meal cooking container 1 shown in FIGS. 3 to 6, the flange part 4 is provided around the upper end part (opening) of the side wall part 3, but the individual meal cooking container 1 may be configured by omitting such a flange part 4. When such a configuration is adopted, the upper end part of the side wall part 3 forms a sticking surface with the seal part.

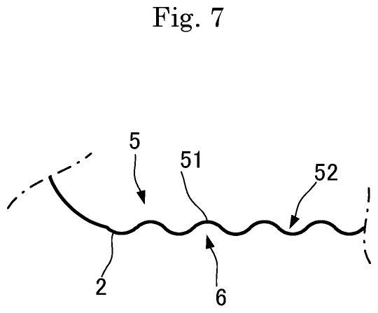

Additionally, in the individual meal cooking container 1 shown in FIGS. 3 to 6, as shown in FIG. 5, the individual meal cooking container 1 is configured such that the flat inner surface 2a of the bottom surface part 2 appears between the protrusions 51. However, the present invention is not limited to such a configuration, and as shown in FIG. 7, the inner surface of the bottom surface part 2 may be configured to have no flat part, for example.

### DESCRIPTION OF REFERENCE SIGNS

S1 rice washing step
S2 supply step
S3 cooking step
S4 sealing step
S5 sterilization step
1 individual meal cooking container
2 bottom surface part
3 side wall part
4 flange part
5 rough surface part
51 protrusion
51a first protrusion
51b second protrusion
511 one protrusion group
512 other protrusion group
6 recess
91 container supply device
92 conveyance device
93 rice-washing and rice-supplying device
94 water supply device
95 rice cooking chamber
96 sealing device
97 heat sterilization device

1. A method for producing cooked rice for individual consumption using non-immersed rice comprising:
a rice washing step of washing rice;
a supply step of supplying washed rice and water into an individual meal cooking container having an open upper surface;
a cooking step of cooking the individual meal cooking container to which rice and water are supplied with steam;
a sealing step of sealing an upper opening of the individual meal cooking container containing the cooked rice; and
a sterilization step of heating the sealed individual meal cooking container,
wherein in the rice washing step, rice is washed with warm water at 30° C. or more and 80° C. or less.

2. The method for producing cooked rice for individual consumption using non-immersed rice according to claim 1, wherein in the rice washing step, rice is washed with the warm water for a time of 2 minutes or more and 5 minutes or less.

3. The method for producing cooked rice for individual consumption using non-immersed rice according to claim 1, wherein in the supply step, a temperature of the water supplied into the individual meal cooking container is lower than a temperature of the warm water used in the rice washing step.

4. The method for producing cooked rice for individual consumption using non-immersed rice according to claim 1, wherein a moisture content of rice at the end of the rice washing step is 18% or more and 28% or less.

5. The method for producing cooked rice for individual consumption using non-immersed rice according to claim 1, wherein a rice cooking ratio of the cooked rice is 2.3 or more and 2.6 or less.

6. The method for producing cooked rice for individual consumption using non-immersed rice according to claim 1, wherein the individual meal cooking container includes a bottom surface part and a side wall part erected from a periphery of the bottom surface part, the bottom surface part has a rough surface part, and the rough surface part is formed of a plurality of minute protrusions protruding from an inner surface of the bottom surface part and arranged at predetermined intervals.
